(19) United States
(12) Patent Application Publication
(10) Pub. No.: US 2010/0101135 A1
(43) Pub. Date: Apr. 29, 2010

(54) Method of Scenting Hunting Clothing and Related Gear

(76) Inventor: Charles Robert Sligh, Pleasant Hill, IA (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/605,886

(22) Filed: Oct. 26, 2009

Related U.S. Application Data
(60) Provisional application No. 61/108,407, filed on Oct. 24, 2008.

(51) Int. Cl. A01M 31/00; B65B 55/00

(52) U.S. Cl. 43/1; 53/431

(57) ABSTRACT

A method for masking human scent on clothing and gear for used for hunting is provided. The method involves filling a breathable bag with natural materials, such as leaves, twigs, needles and other foliage. The natural scent of the materials is transferred to the clothing and gear using a dryer. The natural scent effectively masks the hunter's human scent.

This application claims priority to provisional patent application No. 61/108407, filed Oct. 24, 2008 and herein incorporates the provisional patent application by reference.

### BACKGROUND OF THE INVENTION

1. Field

The present invention relates to a method of scenting clothing and, more particularly, to a method of scenting clothing to be used for hunting with a natural scent.

2. Background

Many animals have a very highly developed sense of smell. Animals use their sense of smell as a defense mechanism; when an animal smells a human, it typically will avoid the area of the human scent or run away. Hunters use many techniques or products to prevent their target from picking up their scent, including trying to place themselves downwind of the target or attempting to remove the human scent from their person.

One common product for removing human scent from hunting clothing involves the use of charcoal to absorb the human scent from clothing. These products can be expensive, for example, if the charcoal is imbedded in the clothing itself. U.S. Pat. Nos. 5,383,236 and 5,539,930 are examples of such specialized clothing. Additional methods, such as that described in U.S. Pat. No. 5,891,391 require purchase of activated charcoal and a deodorizer to remove scent from clothing.

The need exists in the art for a reusable, inexpensive way to mask a hunter's scent.

### SUMMARY OF THE INVENTION

One object of the present invention is to provide a method of masking a hunter's scent.

Another object of the present invention is to provide an inexpensive, reusable method for masking a hunter's scent.

A further object of the present invention is to provide a natural, chemical-free method for masking a hunter's scent.

These and other objects of the present invention will become apparent to those skilled in the art upon reference to the following specification, drawings, and claims.

The present invention intends to overcome the difficulties encountered heretofore. To that end, a method of scenting hunting apparel or gear is provided. A bag filled with natural material, such as foliage, leaves, needles, and twigs is used to mask human scent.

### BRIEF DESCRIPTION OF THE DRAWINGS

FIG. 1 shows the bag of the present invention.

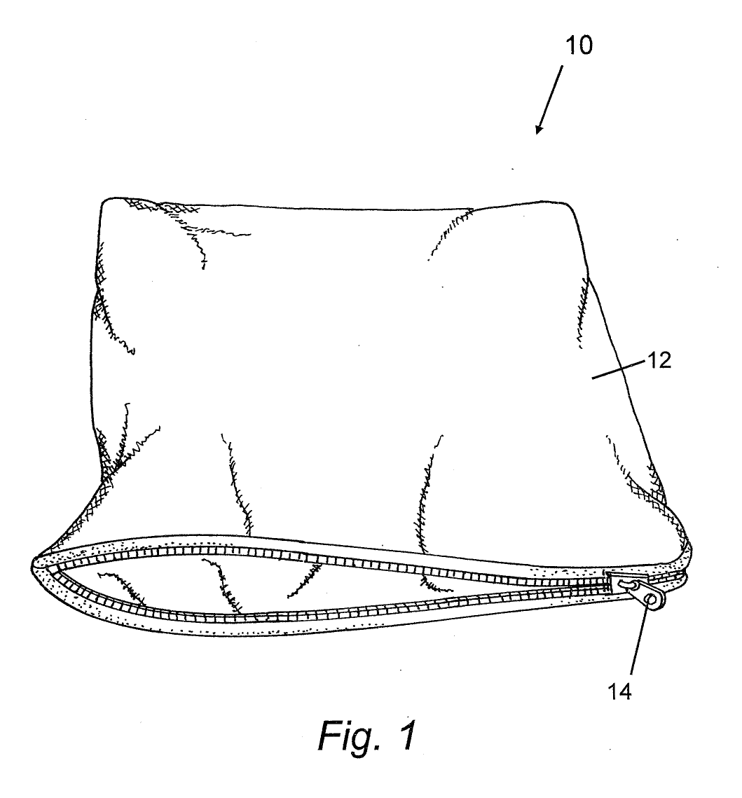

### DETAILED DESCRIPTION OF THE INVENTION

A bag 10 for scenting hunting apparel is provided. The bag 10 is adapted to receive natural foliage material 12, such as leaves, pine needles, twigs, and other foliage. In the preferred embodiment, the foliage is fresh and not dried. The bag 10 is typically made from a breathable material, such as mesh or other fabric. The bag 10 has an opening to allow for filling the bag 10 with foliage 12, and the opening is then sealed, typically with a zipper 14.

Once the bag 10 has been filled with foliage 12, the scent of the foliage is transferred to the apparel. One procedure for transferring the scent is to place the clothing and the bag 10 in a clothes dryer and to operate the clothes dryer. The bag 10 with the foliage 12 may be wetted before cycling the bag 10 and clothes through the dryer. The foliage 12 itself remains in the bag and is not transferred to the clothing. Typically the dryer is operated on a heat-free setting.

After the bag 10 and clothing has been cycled through the dryer, the clothing and bag 10 can be placed in a sealed container to further transfer the scent and maintain the natural scent on the clothing. The clothing does not have to immediately place the clothing in a sealed container, however. After the dryer has cycled, the clothing is ready to be worn on a hunt.

In another method of using the bag 10, the bag 10 with the foliage inside is stored with the clothing inside a sealed container. The scent of the foliage 12 is then transferred to the clothing while in the container. Multiple bags 10 can be used in this application to ensure complete masking of human scent.

In order to completely ensure that the clothing remains completely scented, the hunter may transport the sealed container to the site of the hunt before removing the clothing from the container and dressing.

The empty bag 10 may be washed prior to used. Preferably it is washed in scent-free soap and hung outside to dry.

The methods described have several advantages. First, the scent that is transferred to the clothing is completely natural. There are no artificial, synthetic, or chemical scents that are transferred to the clothing in these methods, which could be detected by animals. Further, the methods are very inexpensive. Pre-scented or deodorized clothing must be replaced frequently, and many of the deodorizers on the market require replacement of carbon, baking soda, etc. that absorb odors. In the present invention, the scenting material is naturally occurring. The hunter simply needs to step outside and collect natural materials in order to prepare the scent bag 10 of the present invention.

Further, in this invention, the clothing is not being deodorized. Instead, the human smell is being covered or masked by naturally occurring smells that are natural to the animal's environment. The treated apparel has a strong, natural odor that dominates or masks the human scent.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention. For example the methods described are not limited to clothing. Any materials that can be cycled through a dryer can be scenting according to the above described methods.

1. A method of scenting hunting apparel and gear prior to a hunt comprising the steps of:
a) providing a breathable container for receiving natural materials;
b) filling the container with natural materials;
c) placing the filled container in a dryer;
d) placing the hunting apparel or gear in the dryer; and
e) operating the dryer.

2. The method of claim 1, further comprising the step of wetting the filled container prior to operating the dryer.

3. The method of claim 1, wherein the container is made from mesh.

4. The method of claim 1, wherein the natural materials are foliage.

5. The method of claim 1, wherein the natural materials are leaves.

6. The method of claim 1, wherein the natural materials are needles.

7. The method of claim 1, wherein the natural materials are twigs.

8. The method of claim 1 further comprising the step of storing the breathable container and the scenting clothing or gear in a sealed storage container after operation of the dryer.

9. The method of claim 8 further comprising the step of transporting scented apparel or gear to the location of the hunt inside of the sealed storage container.

10. A method of scenting hunting apparel and gear prior to a hunt comprising the steps of:
a) washing the apparel or gear;
b) drying the apparel or gear;
c) placing the apparel or gear in a sealable container;
d) placing at least one bag filled with natural material inside of the sealable container; and
e) sealing the container.

11. The method of claim 10, further comprising the step of placing additional filled bags between layers of apparel or gear.
